(19) United States
(12) Patent Application Publication
(10) Pub. No.: US 2013/0129274 A1
(43) Pub. Date: May 23, 2013

(54) OPTICAL FIBER HAVING A MODIFIED EXTERIOR PORTION THAT IMPROVES ADHESION TO AN EXTERIOR MATERIAL OR STRUCTURE, AND A METHOD FOR IMPROVING ADHESION CHARACTERISTICS OF AN OPTICAL FIBER

(71) Applicant: Michael Warber, Regensburg (DE)

(72) Inventor: Michael Warber, Regensburg (DE)

(73) Assignee: AVAGO TECHNOLOGIES FIBER IP (SINGAPORE) PTE. LTD., SINGAPORE (SG)

(21) Appl. No.: 13/301,869

(22) Filed: Nov. 22, 2011

(51) Int. Cl. G02B 6/10; C03B 37/01; B29D 11/00

(52) U.S. Cl. 385/12; 264/1.24; 65/402

(57) ABSTRACT

The shape of the exterior surface of a portion of an optical fiber that is to be attached to, or embedded in, an external structure or material is modified to improve the adhesion characteristics of that portion of the fiber. Improving the adhesion characteristics of that portion of the fiber allows a very strong bond to be formed between it and the structure or material to which it is attached or in which it is embedded. Strengthening this bond helps prevent relative movement from occurring between the fiber and the exterior material or structure to which it is attached or in which it is embedded.

### TECHNICAL FIELD OF THE INVENTION

The invention relates to optical fibers, and more particularly, to an optical fiber having a modified exterior portion that provides improved adhesion to an exterior material to which the fiber is attached or embedded.

### BACKGROUND OF THE INVENTION

Optical fibers are used in a variety of environments for a variety of purposes. The predominant environment in which optical fibers are used is optical networks. The predominant purpose for which optical fibers are used is to transmit optical data signals between an optical transmitter and an optical receiver. On the transmitter end, electrical data signals are converted into optical data signals, which are then transmitted over the optical fiber. On the receiver end, the optical data signals passing out of the end of the optical fiber are converted into electrical data signals.

Optical fibers are also used in environments other than optical networks and for purposes other than carrying optical data signals. In recent years, optical fibers have been used as load sensors for sensing the load, or stress, placed on a structure. The structure may be, for example, a concrete piling used in a building, a tower, a rotor blade of a windmill, or a wing of an airplane.

In such environments, a portion of the load-sensing fiber is embedded in or attached to the structure. Typically, an adhesive material, such as epoxy, is used to attach the load-sensing fiber to the structure. The ends of the load-sensing fiber are optically coupled to measurement equipment. A reference optical fiber having precisely the same length as the load-sensing fiber is typically laid along side the measurement equipment at a location that is external to the material or structure. The ends of the reference fiber are also optically coupled to the measurement equipment. A laser diode or a light emitting diode (LED) of the measurement equipment is modulated to produce a modulated light beam. An optical splitter of the measurement equipment splits the modulated light beam into first and second modulated light beams, which are then optically coupled into the ends of the load-sensing fiber and the reference fiber that are optically coupled to the measurement equipment.

The first and second modulated light beams propagate along the two fibers and pass out of the opposite ends of the fibers. The measurement equipment includes first and second optical sensors that receive the respective light beams and convert the respective light beams into respective electrical signals. Electrical circuitry of the measurement equipment processes the electrical signals to determine any phase differences between them. The phase differences are then used to determine any differences in the lengths of the two fibers as a function of time.

If stress on the load-sensing fiber has caused it to become elongated, the measurement equipment will use the measured phase differences to calculate the extent of the elongation over time. The extent of the elongation over time may be used to characterize the stress that has been placed on the structure over time, which, in turn, may be used as a factor in determining the integrity of the structure.

Because the exterior surfaces of optical fibers are smooth, the bond between the exterior surface of the load-sensing fiber and the structure can be difficult to maintain. Consequently, the bond sometimes becomes compromised or fails. One reason for this is that the coefficients of thermal expansion (CTEs) of the structure and of the fiber are often different, which can contribute to the bond becoming compromised or failing due to temperature fluctuations over time. If the bond fails or otherwise becomes compromised, the accuracy of the phase difference measurements can degrade. If accurate phase difference measurements cannot be obtained, the calculations of the elongation of the load-sending fiber cannot be used with confidence as a factor in assessing the integrity of the structure.

Accordingly, a need exists for a way to ensure that the bond between the load-sensing fiber and the external structure does not become compromised or fail over time.

### SUMMARY OF THE INVENTION

The invention is directed to an optical fiber having an improved adhesion characteristic, a method for providing an optical fiber with an improved adhesion characteristic, and a method for embedding a load-sensing optical fiber having an improved adhesion characteristic in a material to create a form enclosure of the material about a portion of the optical fiber that has the improved adhesion characteristic.

The optical fiber has a core, an exterior surface surrounding the core, and a pattern formed in the exterior surface of the fiber along a portion of the fiber. The pattern corresponds to a modification to the shape of the exterior surface of the fiber along the portion of the fiber. The modification to the shape of the exterior surface of the fiber provides the patterned portion of the fiber with an enhanced adhesion characteristic that facilitates mechanically coupling the patterned portion of the fiber with an external structure or material.

The method for providing the fiber with an improved adhesion characteristic comprises placing an exterior surface of a portion of an optical fiber in contact with a shape modifying tool, and using the shape modifying tool to form a pattern in the exterior surface of the portion of the optical fiber. The pattern corresponds to a modification in a shape of the exterior surface of the portion of the optical fiber.

The method for embedding a portion of a load-sensing optical fiber in a material such that the material forms a form enclosure about the portion of the load-sensing optical fiber comprises the following steps. A load-sensing optical fiber having a pattern formed in an exterior surface of a portion thereof is provided. The pattern corresponds to a modification of the shape of the exterior surface of the portion of the fiber. The patterned portion of the fiber is then embedded in a non-solid external material. The external material is then solidified. Solidifying the external material creates a form enclosure about the patterned portion of the optical fiber. The form enclosure provides a strong mechanical coupling between the patterned portion of the fiber and the solidified material that helps prevent relative movement of the patterned portion of the fiber and the solidified material.

These and other features and advantages of the invention will become apparent from the following description, drawings and claims.

### BRIEF DESCRIPTION OF THE DRAWINGS

FIG. 1 illustrates a plan view of a plastic optical fiber (POF) and a shape modifying tool in accordance with an illustrative embodiment that will be used to modify the shape of an exterior surface of the POF to improve its adhesion characteristics.

FIG. 2 illustrates a plan view of a POF and a shape modifying tool in accordance with another illustrative embodiment that will be used to modify the shape of an exterior surface of the POF to improve its adhesion characteristics.

FIG. 3 illustrates a plan view of a POF and a shape modifying tool in accordance with another illustrative embodiment that will be used to modify the shape of an exterior surface of the POF to improve its adhesion characteristics.

FIG. 4 is a flowchart that represents a method for improving the adhesion characteristics of an exterior surface of a portion of an optical fiber in accordance with an illustrative embodiment.

FIG. 5 is a flowchart that represents a method for embedding a load-sensing optical fiber in an external material such that the external material creates a form enclosure about a portion of the fiber that has a patterned exterior surface.

FIG. 6 illustrates a plan view of the POF shown in FIG. 1 embedded in an external material or structure.

### DETAILED DESCRIPTION OF ILLUSTRATIVE EMBODIMENTS

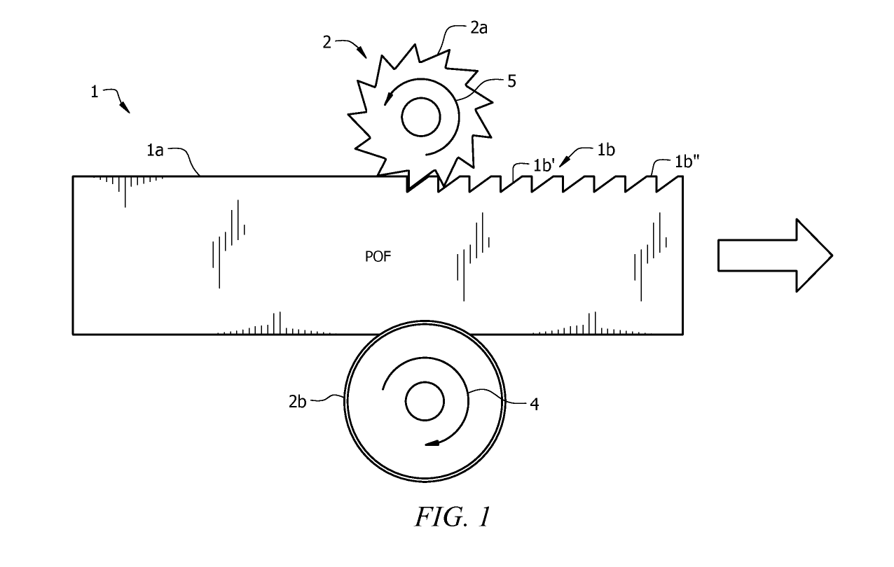

In accordance with illustrative, or exemplary, embodiments, the shape of the exterior surface of a portion of an optical fiber that is to be attached to, or embedded in, an external structure or material is modified to improve the adhesion characteristics of that portion of the fiber. Improving the adhesion characteristics of that portion of the fiber allows a very strong bond to be formed between it and the structure or material to which it is attached or in which it is embedded. Strengthening this bond helps prevent relative movement from occurring between the fiber and the exterior material. Illustrative, or exemplary, embodiments will now be described with reference to FIGS. 1-4.

FIGS. 1-3 illustrate non-limiting examples of various types of tools and methods that may be used to modify the shape of the exterior surface of an optical fiber along a portion of the optical fiber that is intended to be attached to, or embedded in, an external material or structure. Although the invention applies equally to plastic optical fibers (POFs) and glass fibers, because POFs rather than glass fibers are typically used as load-sensing fibers, the invention will be described with reference to POFs for exemplary purposes.

With reference to FIG. 1, a plan view of a POF 1 and a shape modifying tool 2 is shown. In accordance with this illustrative embodiment, the shape-modifying tool 2 includes a saw blade 2a and a pressure roller 2b. The POF 1 is disposed in between the saw blade 2a and the pressure roller 2b and is in contact with the saw blade 2a and the pressure roller 2b. The saw blade 2a has a saw-tooth shape. The POF 1 is pulled in the direction indicated by arrow 3. The pressure roller 2b presses the POF 1 upwards against the saw blade 2a. The pressure roller 2b turns in the direction indicated by arrow 4 and the saw blade 2a turns in the direction indicated by arrow 5.

As the saw blade 2a turns, the saw-tooth shape of the blade 2a is transferred into the exterior surface 1a of the POF 1 to form a saw-tooth pattern 1b in the exterior surface 1a of the POF 1. In this way, the shape of the exterior surface 1a of a portion of the POF 1 is modified. The saw-tooth pattern 1b is only formed in the jacket of the POF 1 and does not extend into the core of the POF 1. Therefore, the saw-tooth pattern 1b does not affect the optical qualities or performance of the POF 1.

Modifying the shape of the exterior surface 1a of the POF 1 provides the POF 1 with enhanced adhesion characteristics, particularly when the POF 1 is embedded in a structure or material. For example, if the modified portion of the POF is embedded in concrete prior to the concrete hardening, the liquid concrete will fill the valleys 1b′ of the saw-tooth pattern 1b that are located in between the peaks 1b″ of the saw-tooth pattern 1b. When the concrete hardens, it will create a form enclosure about the modified portion of the POF 1. This form enclosure is not a friction fit, but is a much stronger mechanical coupling between the POF 1 and the surrounding concrete. The bond created by the resulting form enclosure is extremely strong and cannot be easily broken or compromised.

The same is true if the surrounding material or structure is made of plastic. In that case, the modified portion of the POF 1 is placed in a mold that will be used to mold the structure. Liquid resin is then poured into the mold. The liquid resin will fill valleys 1b′ of the saw-tooth pattern 1b that are located in between peaks 1b″ of the saw-tooth pattern 1b. When the resin hardens, it will create a form enclosure about the modified portion of the POF 1. The resulting form enclosure is not a friction fit, but is a much stronger mechanical coupling between the POF 1 and the surrounding plastic. Therefore, the resulting bond is extremely strong and cannot be easily broken or compromised.

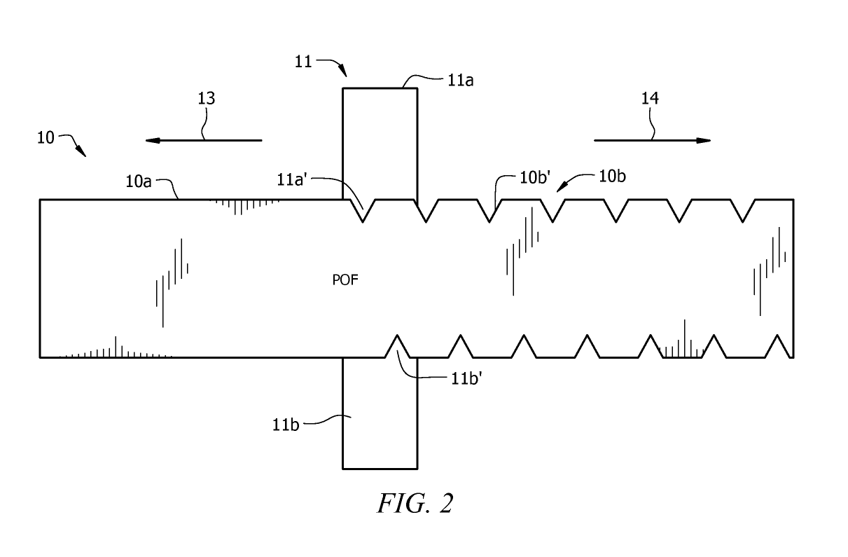

With reference to FIG. 2, a plan view of a POF 10 and a shape modifying tool 11 in accordance with another illustrative embodiment is shown. In accordance with this illustrative embodiment, the shape-modifying tool 11 is a stamping tool that includes an upper cutting die 11a and a lower cutting die 11b. The upper and lower cutting dies 11a and 11b have pointed teeth 11a′ and 11b′, respectively, thereon. The POF 10 is disposed in between the upper and lower cutting dies 11a and 11b. The stamping tool 11 and/or the POF 10 is moved in the directions indicated by arrows 13 and 14 to produce relative movement between the POF 10 and the tool 11 in the axial (i.e., longitudinal) directions of the POF 10. As this relative movement occurs, the dies 11a and 11b are moved away from the POF 10 and into the POF 10 such that the pointed teeth 11a′ and 11b′ punch the exterior surface 10a of the POF 10. This causes the shape of the pointed teeth 11a′ and 11b′ to be transferred into the exterior surface 10a of the POF 10 to form a punched pattern 10b. In this way, the shape of the exterior surface 10a of a portion of the POF 10 is modified.

The punched pattern 10b is only formed in the jacket of the POF 10 and does not extend into the core of the POF 10. Therefore, the punched pattern 10b does not affect the optical qualities or performance of the POF 10. Modifying the shape of the exterior surface 10a of the POF 10 provides the POF 10 with enhanced adhesion characteristics, particularly when the POF 10 is embedded in a structure or material. For example, if the modified portion is embedded in concrete or resin prior to the concrete or resin hardening, the liquid concrete or resin will fill the teeth imprints 10b′. When the concrete or resin hardens, it will create a form enclosure about the modified portion of the POF 10. As indicated above, this form enclosure is not a friction fit, but is a much stronger mechanical coupling between the POF 10 and the surrounding hardened concrete or resin. The bond created by the resulting form enclosure is extremely strong and cannot be easily broken or compromised.

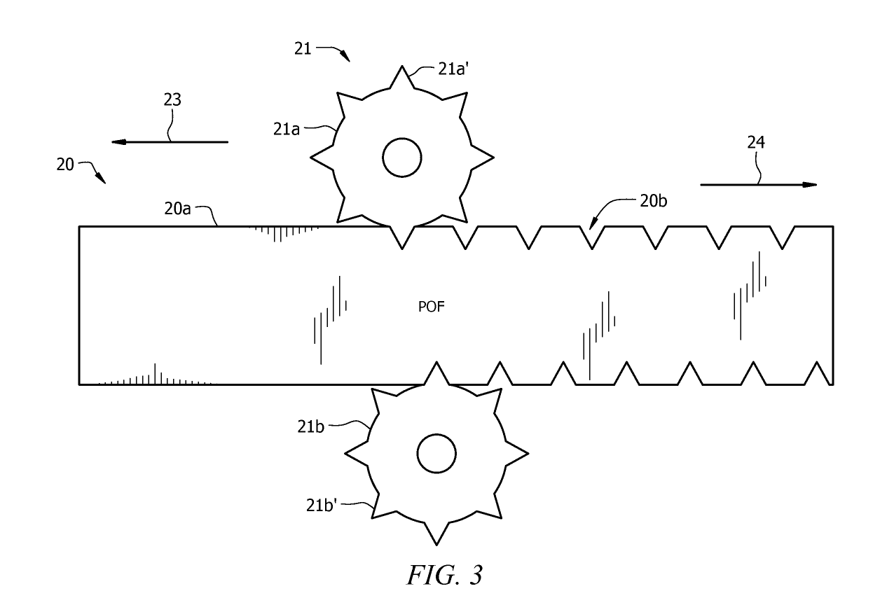

Modifications in the shape of the exterior surface of a portion of a POF or glass fiber may be made in ways other than those described above with reference to FIGS. 1 and 2. For example, hot or cold embossing techniques may be used for this purpose. With reference to FIG. 3, a plan view of a POF 20 and a shape modifying tool 21 is shown. In accordance with this illustrative embodiment, the shape-modifying tool 21 is an embossing tool that includes an upper embossing plate 21a and a lower embossing plate 21b. The upper and lower embossing plates 21a and 21b have pointed teeth 21a′ and 21b′, respectively, thereon. The POF 20 is disposed in between the upper and lower embossing plates 21a and 21b.

The embossing tool 21 and/or the POF 20 is moved in the directions indicated by arrows 23 and 24 to produce relative movement between the POF 20 and the tool 21 in the axial directions of the POF 20. As this relative movement occurs, the plates 21a and 21b transfer the shape of the pointed teeth 21a′ and 21b′ into the exterior surface 20a of the POF 20 to form an embossed pattern 20b in the exterior surface 20a of the POF 20. In this way, the shape of the exterior surface 20a of a portion of the POF 20 is modified.

The embossed pattern 20b is only formed in the jacket of the POF 20 and does not extend into the core of the POF 20. Therefore, the embossed pattern 20b does not affect the optical qualities or performance of the POF 20. Modifying the shape of the exterior surface 20a of the POF 20 provides the POF 20 with enhanced adhesion characteristics as described above with reference to FIGS. 1 and 2. The resulting bond is extremely strong and cannot be easily broken or compromised.

While the techniques described above with reference to FIGS. 1-3 all achieve a modification of the fiber jacket, the technique described with reference to FIG. 1 removes portions of the jacket in order to form the pattern whereas the techniques described with reference to FIGS. 2 and 3 do not remove portions of the fiber jacket in order to form the patterns. Therefore, the patterns may be formed using a variety of techniques and tools. It should also be noted that while the patterns shown in FIGS. 1-3 consist of shapes (e.g., valleys 1b′ of pattern 1b in FIG. 1) that repeat at constant spatial intervals in the axial directions of the fibers, it is not necessary to the invention that the shapes that make up the patterns repeat at fixed, i.e., constant, spatial intervals. The shapes that make up a given pattern may occur at spatial intervals that are not constant, i.e., that occur at varying spatial intervals. Also, the shapes that make up a pattern need not be identical. For example, the embossing plate 21a shown in FIG. 3 may have both pointed teeth 21a′ and blunt teeth (not shown) so that the features of the pattern 20b are not all identical to each other.

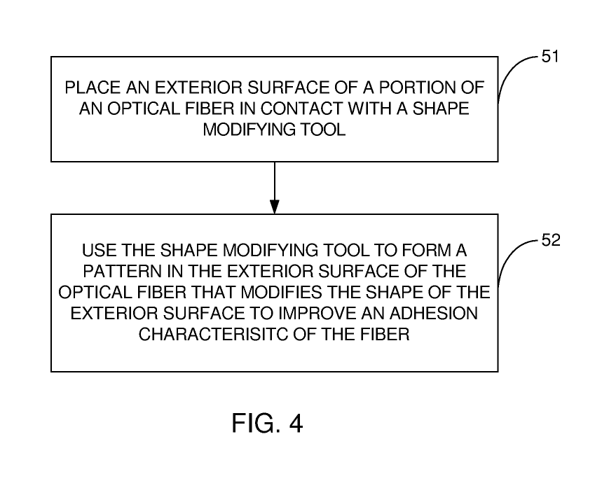

FIG. 4 is a flowchart that represents a method for improving the adhesion characteristics of an exterior surface of a portion of an optical fiber in accordance with an illustrative embodiment. An exterior surface of a portion of an optical fiber is placed in contact with a shape modifying tool, as indicated by block 51. The shape modifying tool is then used to modify the shape of the exterior surface of the portion of the optical fiber by forming a predetermined pattern in the exterior surface of the portion of the fiber in order to improve an adhesion characteristic of the exterior surface, as indicated by block 52. The pattern may be formed in the exterior surface of the entire length of fiber, but is only needed on the portion of the fiber that will be attached to, or embedded in, the external material or structure. As indicated above, the pattern may consist of one particular shape that repeats at fixed spatial intervals or may consist of different shapes that repeat at either fixed spatial intervals or varying spatial intervals.

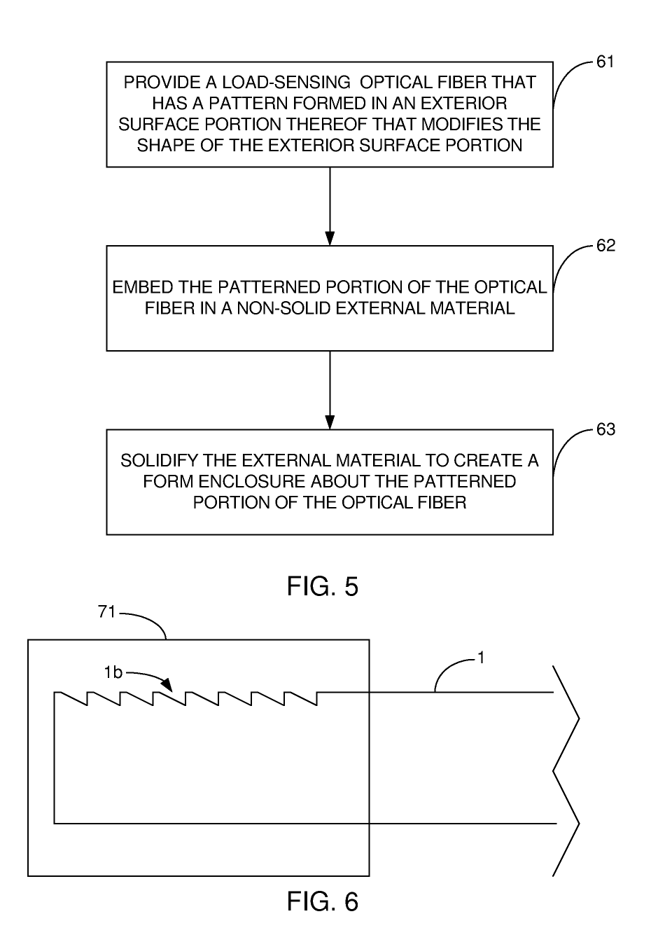

FIG. 5 is a flowchart that represents a method for embedding a load-sensing optical fiber in an external material such that the external material creates a form enclosure about a portion of the fiber that has a patterned exterior surface. An optical fiber is provided that has a pattern formed in a portion of an exterior surface thereof that corresponds to a modification to the shape of the exterior surface, as indicated by block 61. Modifying the shape of the exterior surface improves an adhesion characteristic of the fiber. The portion of the optical fiber that includes the patterned exterior surface is embedded in a non-solid exterior material, as indicated by block 62. The exterior material is then solidified to create a form enclosure about the portion of the optical fiber that is embedded therein, as indicated by block 63. The form enclosure that is formed about the patterned portion of the load-sensing fiber creates a very strong mechanical bond between the embedded fiber portion and the exterior material that prevents relative movement between them.

FIG. 6 illustrates a plan view of the POF 1 shown in FIG. 1 embedded in an external material or structure 71, which is transparent in this illustrative embodiment. The external material or structure 71 forms a form enclosure about the portion of the POF 1 in which the pattern 1b has been formed. The portion of the POF 1 in which the pattern 1b has been formed has improved adhesion characteristics. As indicated above, this form enclosure is not a friction fit, but is a much stronger mechanical coupling between the POF 1 and the surrounding material or structure 71. The bond created by the resulting form enclosure is extremely strong and cannot be easily broken or compromised.

It should be noted that embodiments have been described herein for the purpose of demonstrating the principles and concepts of the invention. As will be understood by persons skilled in the art in view of the description being provided herein, the invention is not limited to these embodiments. For example, the invention is not limited with respect to the tools that are used to form the patterns in the exterior surfaces of the fibers or with respect to the shape of the pattern. The patterns may be formed as part of the fiber manufacturing process or during a separate process that is performed after the fiber manufacturing process has been performed.

What is claimed is:

1. An optical fiber comprising:
a core;
an exterior surface surrounding the core; and
a pattern formed in the exterior surface of the fiber along a portion of the fiber, wherein the pattern corresponds to a modification to the shape of the exterior surface of the fiber along the portion of the fiber, and wherein the modification to the shape of the exterior surface provides the patterned portion of the fiber with an enhanced adhesion characteristic that facilitates mechanically coupling the patterned portion of the fiber with an external structure or material.

2. The optical fiber of claim 1, wherein the optical fiber is a plastic optical fiber (POF).

3. The optical fiber of claim 1, wherein the optical fiber is a glass optical fiber.

4. The optical fiber of claim 1, wherein the pattern comprises a first shape that repeats at constant spatial intervals along the patterned portion of the optical fiber in an axial direction of the optical fiber.

5. The optical fiber of claim 1, wherein the pattern comprises a first shape that repeats at non-constant spatial intervals along the patterned portion of the optical fiber in an axial direction of the optical fiber.

6. The optical fiber of claim 1, wherein the pattern comprises at least first and second shapes that repeat at constant spatial intervals along the patterned portion of the optical fiber in an axial direction of the optical fiber, and wherein the first and second shapes are different from each other.

7. The optical fiber of claim 1, wherein the pattern comprises at least first and second shapes that repeat at non-constant spatial intervals along the patterned portion of the optical fiber in an axial direction of the optical fiber, and wherein the first and second shapes are different from each other.

8. A method for providing an exterior surface of a portion of an optical fiber with an improved adhesion characteristic, the method comprising:
placing an exterior surface of a portion of an optical fiber in contact with a shape modifying tool; and
using the shape modifying tool to form a pattern in the exterior surface of the portion of the optical fiber, wherein the pattern corresponds to a modification in a shape of the exterior surface of the portion of the optical fiber.

9. The method of claim 8, wherein the optical fiber is a plastic optical fiber (POF).

10. The method of claim 8, wherein the optical fiber is a glass optical fiber.

11. The method of claim 8, wherein the pattern comprises a first shape that repeats at constant spatial intervals along the patterned portion of the optical fiber in an axial direction of the optical fiber.

12. The method of claim 8, wherein the pattern comprises a first shape that repeats at non-constant spatial intervals along the patterned portion of the optical fiber in an axial direction of the optical fiber.

13. The method of claim 8, wherein the pattern comprises at least first and second shapes that repeat at constant spatial intervals along the patterned portion of the optical fiber in an axial direction of the optical fiber, and wherein the first and second shapes are different from each other.

14. The method of claim 8, wherein the pattern comprises at least first and second shapes that repeat at non-constant spatial intervals along the patterned portion of the optical fiber in an axial direction of the optical fiber, and wherein the first and second shapes are different from each other.

15. The method of claim 8, wherein the shape modifying tool is a cutting tool that cuts the exterior surface of the portion of the optical fiber to form the pattern.

16. The method of claim 8, wherein the shape modifying tool is a punching tool that punches the exterior surface of the portion of the optical fiber to form the pattern.

17. The method of claim 8, wherein the shape modifying tool is an embossing tool that embosses the exterior surface of the portion of the optical fiber to form the pattern.

18. A method of embedding a portion of a load-sensing optical fiber in a material such that the material forms a form enclosure about the portion of the load-sensing optical fiber, the method comprising:
providing a load-sensing optical fiber having a pattern formed in an exterior surface of a portion of the fiber, the pattern corresponding to a modification of the shape of the exterior surface of the portion of the fiber;
embedding the patterned portion of the fiber in a non-solid external material;
solidifying the exterior material to create a form enclosure about the patterned portion of the optical fiber, and wherein the form enclosure provides a strong mechanical coupling between the patterned portion of the fiber and the solidified material that helps prevent relative movement of the patterned portion of the fiber and the solidified material.

19. The method of claim 18, wherein the optical fiber is a plastic optical fiber (POF).

20. The method of claim 18, wherein the optical fiber is a glass optical fiber.

21. The method of claim 18, wherein the pattern comprises a first shape that repeats at constant spatial intervals along the patterned portion of the optical fiber in an axial direction of the optical fiber.

22. The method of claim 18, wherein the pattern comprises a first shape that repeats at non-constant spatial intervals along the patterned portion of the optical fiber in an axial direction of the optical fiber.

23. The method of claim 18, wherein the pattern comprises at least first and second shapes that repeat at constant spatial intervals along the patterned portion of the optical fiber in an axial direction of the optical fiber, and wherein the first and second shapes are different from each other.

24. The method of claim 18, wherein the pattern comprises at least first and second shapes that repeat at non-constant spatial intervals along the patterned portion of the optical fiber in an axial direction of the optical fiber, and wherein the first and second shapes are different from each other.

25. The method of claim 18, wherein the shape modifying tool is a cutting tool that cuts the exterior surface of the portion of the optical fiber to form the pattern.

26. The method of claim 18, wherein the shape modifying tool is a punching tool that punches the exterior surface of the portion of the optical fiber to form the pattern.

27. The method of claim 18, wherein the shape modifying tool is an embossing tool that embosses the exterior surface of the portion of the optical fiber to form the pattern.
